(19) United States
(12) Patent Application Publication
(10) Pub. No.: US 2004/0158442 A1
(43) Pub. Date: Aug. 12, 2004

(54) Simulation method, apparatus, and computer program using hybrid model

(76) Inventor: Koichi Kondo, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/721,544

(22) Filed: Nov. 26, 2003

(30) Foreign Application Priority Data
Nov. 27, 2002 (JP) 2002-344228

(51) Int. Cl. G06F 17/50

(52) U.S. Cl. 703/1

(57) ABSTRACT

A simulation method of simulating a behavior or a mechanism using a hybrid model including a state transition model and a continuous system model. The hybrid model is analyzed to extract a first description data of the state transition model and a second description data of the continuous system model. The method includes generating a table representing a relationship between continuous system equations and switching conditions thereof, based on the extracted first description data. The method also includes generating a plurality of internal data expressions of the continuous system equations, based on the extracted second description data.

### CROSS-REFERENCE TO RELATED APPLICATIONS

This application is based upon and claims the benefit of priority from the prior Japanese Patent Application No. 2002-344228, filed Nov. 27, 2002, the entire contents of which are incorporated herein by reference.

### BACKGROUND OF THE INVENTION

1. Field of the Invention

The present invention relates to a method, apparatus, and computer program, which are used to simulate the behaviors of a machine, plant, and the like using a computer and, more particularly, to a method, apparatus, and computer program, which use a hybrid model.

2. Description of the Related Art

Upon simulating the behaviors of a machine, plant, and the like using a computer, a scheme called hybrid modeling is often used. A simulation using a hybrid model is called a “hybrid simulation”. A system that makes such simulation behavior is also called a “hybrid system”.

A hybrid model, which is generated for the purpose of simulation combines a continuous system model expressed by simultaneous equations of ordinary differential equations or algebraic equations, and a state transition model used to express state transition upon occurrence (establishment) of an event. That is, the hybrid model expresses a system, the state of which is expressed by a continuous system model and is switched instantaneously in response to, e.g., an external event or the like.

As a language that describes a hybrid model, HCC (Hybrid Concurrent Constraint Programming) created at the Xerox (TM) Palo Alto Research Center is known (see U.S. Pat. No. 5,831,853 and “http://www2.parc.com/spl/projects/mbc/publications.htm 1#cclainguages”). HCC is under development, and is currently studied at the NASA Ames Research Center. HCC is a kind of technology called constraint programming, can handle ordinary differential equations or algebraic equations that express a continuous system model as constraints, and can describe these equations in arbitrary order. The hybrid model is completed by adding a description that controls state transition to such constraint description. Such HCC can directly list up (program) equations as constraints, and can describe a complicated model.

As described above, the hybrid model technology can express the system characteristics as a model using ordinary differential equations or the like, and can simulate the behavior from an initial state along with the elapse of time.

As an application example of the hybrid model technology that can adequately model objects and events which can be expressed by differential equations or the like, mechanism simulation of a mechatronics device, the mechanism of which is controlled by software, is known. According to such mechanism simulation, even when no actual mechanism is available, control software that controls the mechanism can undergo prototyping, testing, debugging, or the like.

However, a known programming language that can handle a hybrid model is not always developed for the purpose of application to the mechanism simulation of a mechatronics device, and suffers the following problems.

For example, HCC of Xerox Corporation (TM) is an interpreter type programming language, and a process called GC (Garbage Collection) is launched during simulation. The simulation (its program) is paused until this process is completed. Hence, the execution time of the simulation cannot be accurately recognized. Also, HCC is not suited to implement an application for some other reasons. For example, it is very difficult to generate a simulation program. For example, when an activation command to an actuator, which is transmitted from control software to the mechanism, is to be received as a control signal from outside a simulator, external functions and the like must be independently defined, and many devises are required in programming.

### BRIEF SUMMARY OF THE INVENTION

The present invention is directed to a simulation method, apparatus, and program, which can easily and accurately model a complicated mechanism system using a hybrid model, and are suitable for simulation in collaboration with control software that controls the mechanism system.

According to one aspect of the present invention, there is provided a method of simulating a behavior of a mechanism using a hybrid model including a state transition model and a continuous system model. The hybrid model is analyzed to extract a first description data of the state transition model and a second description data of the continuous system model. The method includes generating a table representing a relationship between continuous system equations and switching conditions thereof, based on the extracted first description data. The method also includes generating a plurality of internal data expressions of the continuous system equations, based on the extracted second description data.

### BRIEF DESCRIPTION OF THE SEVERAL VIEWS OF THE DRAWING

FIG. 1 is a schematic block diagram showing the arrangement of a mechanism simulator according to the first embodiment of the present invention;

FIG. 2 shows a given state of a cylinder device according to a practical example used to explain a hybrid model description;

FIG. 3 shows another state of the cylinder device according to the practical example used to explain the hybrid model description;

FIG. 4 shows state transition of the cylinder device according to the practical example used to explain the hybrid model description;

FIG. 5 shows the contents of the hybrid model description;

FIG. 6 is an explanatory view of an internal data structure obtained as a result of parsing one continuous system equation;

FIG. 7 is a block diagram showing collaboration of mechanism control software and the mechanism simulator;

FIG. 8 is a block diagram when a kinematics simulation unit is included;

FIG. 9 is a flow chart showing the processing sequence of mechanism simulation; and

FIG. 10 is a schematic block diagram showing the arrangement of a mechanism simulator according to the second embodiment of the present invention.

### DETAILED DESCRIPTION OF THE INVENTION

Embodiments of the present invention will be described hereinafter with reference to the accompanying drawings.

### FIRST EMBODIMENTS

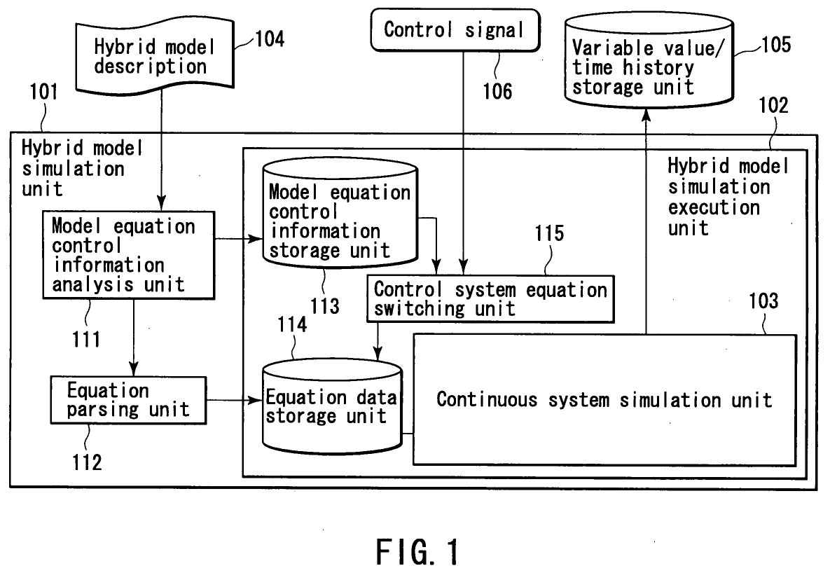

FIG. 1 is a schematic block diagram showing the arrangement of a mechanism simulator according to the first embodiment of the present invention.

A mechanism simulator (hybrid model simulation unit 101) according to the first embodiment of the present invention comprises a model equation control information analysis unit 111, equation parsing unit 112, and hybrid model simulation execution unit 102. A hybrid model description 104 is a source program described in a hybrid model description language such as HCC, and is an input to the mechanism simulator 101 according to this embodiment. A control signal 106 is also an input to the mechanism simulator 101, and is given from mechanism control software or its simulator (to be described later). The output from the mechanism simulator 101 according to this embodiment is the calculation result and time history of variable values as a simulation result, and is supplied to a storage unit 105.

As shown in FIG. 1, the hybrid model simulation execution unit 102 comprises a model equation control information storage unit 113, equation data storage unit 114, continuous system equation switching unit 115, and continuous system simulation unit 103. Note that this embodiment can be implemented using a general purpose computer, which comprises as its basic hardware components a central processing unit (CPU), memory, external recording device, communication interface (I/F), display device, and input device (mouse, keyboard, and the like) (none of them are shown). Also, the computer comprises an operating system (OS) for controlling these hardware components. The mechanism simulator according to the embodiment of the present invention can be implemented as application software, which runs on such operating system.

Prior to a description of the arrangement and processing sequence of the mechanism simulator according to this embodiment, how to describe the hybrid model 104 will be described below taking a practical example.

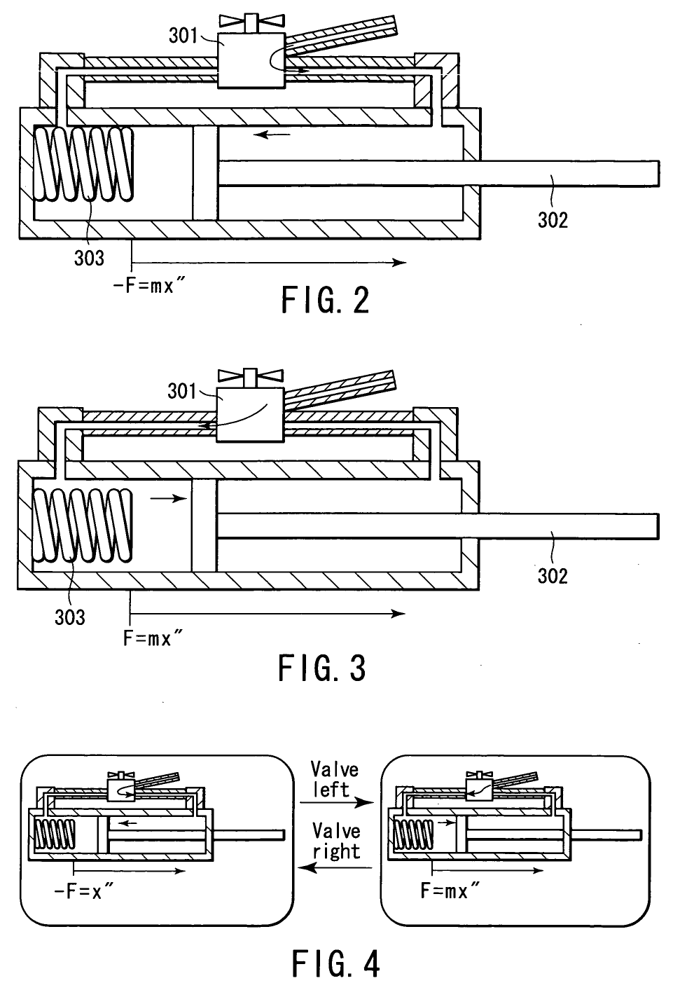

FIGS. 2 and 3 show a mechanical device, a hybrid model of which is to be described according to the practical example. This mechanical device is a cylinder device having a simple structure, which comprises a valve 301, spring 303, and piston 302.

The valve 301 opens/closes in response to an external instruction (event). An event that changes the air flow in the cylinder device to the right side, as shown in FIG. 2, will be referred to as “Right” hereinafter, and an event that changes the air flow to the left side, as shown in FIG. 3, will be referred to as “Left” hereinafter. FIG. 2 shows a state wherein the “Right” event is given to the valve 301, and a leftward force on the plane of paper of FIG. 2 acts on the piston 302. A dynamic equation that expresses this state is [-F=mx″], as indicated by an equation below the cylinder device. By contrast, FIG. 3 shows a state wherein the “Left” event is given to the valve 301. In this state, the air flow direction has changed, and the dynamic equation changes to [F=mx″), as shown in FIG. 3.

FIG. 4 shows such state changes and the dynamic equations corresponding to these states as a state transition chart. A hybrid model expresses the state transition and respective states shown in FIG. 4 described using differential equations or algebraic equations. As can be seen from FIG. 4, there are two states, and state transition occurs between these two states.

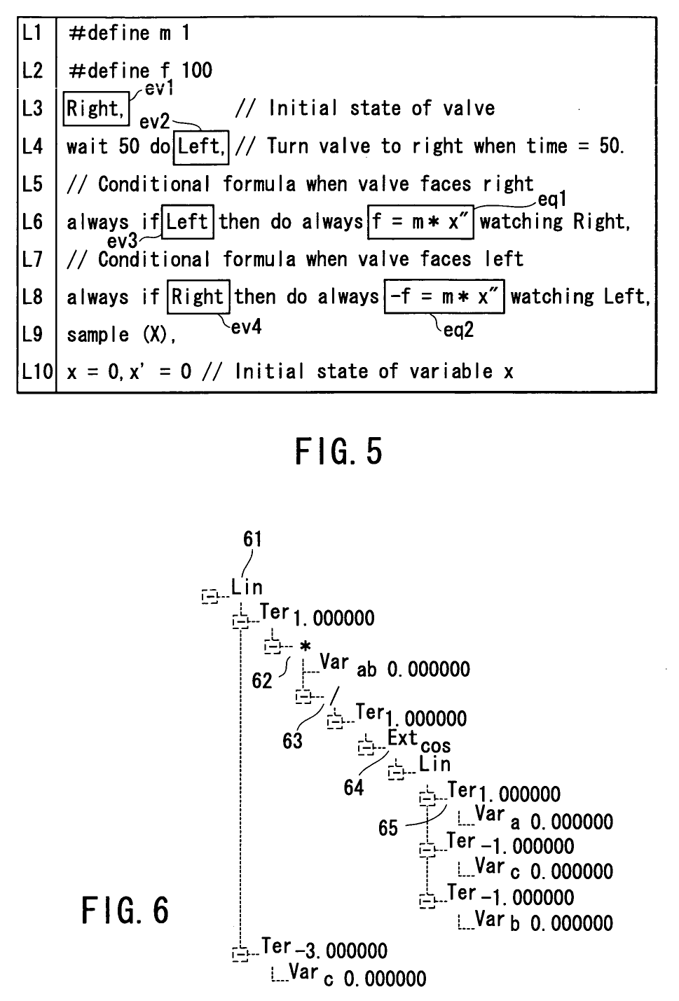

FIG. 5 shows an example of a program which describes the contents of a practical hybrid model using the HCC (Hybrid Concurrent Constraint Programming) language on the basis of the state transition chart in FIG. 4. Referring to FIG. 5, let L1 to L10 be the logical line numbers of a (source) program. L3, L4, and L10 describe the initial state and drive conditions such as a valve manipulation timing and the like of this mechanical device. L6 and L8 correspond to state transition expressions shown in FIG. 4.

In HCC, dynamic equations can be directly described in the program, as can be seen from FIG. 5. A condition required to transit to each state can be described after “always if”, and a condition required to transit from each state can be described after “watching”.

Note that the program described in HCC is not always executed according to its description order (the order of logical line numbers L1→L10 in FIG. 5). In HCC, statements which are to be activated are searched along the time axis along which a simulation is executed, and are executed. That is, the order of logical line numbers L1→L10 is not related to their execution order. For example, at the beginning of the simulation, only L3 and L10 are active. Since event “Right” (ev1) is generated in L3, “Right” as the precondition of L8 is activated, and dynamic equation eq2 described in L8 is activated. That is, the simulation is executed from the left state in FIG. 4.

Furthermore, when the time has reached “50”, L4 is activated, and event “Left” (ev2) is generated to effect the transition condition (after “watching”, i.e. Left) of L8, thus deactivating dynamic equation eq2 in L8. Instead, the precondition of L6 is activated, and dynamic equation eq1 is activated.

Note that the aforementioned program example describes a case wherein state transition occurs in response to external events (ev3, ev4). Of course, the state may change depending on the internal situation. For example, when the valve 301 is not switched in FIG. 2, the moving piston 302 contacts the spring 303, and receives a counter force from the spring 303. That is, state transition may occur in association with the position of the piston 302 even when no external event is input. In such case, the necessity of state transition can be determined by evaluating an evaluation formula (inequality) indicating, e.g., if x is positive.

In general, a hybrid model combines a continuous system model expressed by simultaneous equations of ordinary differential equations or algebraic equations, and a state transition model used to express state transition upon generation of an event. The hybrid model can express a system, the state of which is expressed by the continuous system model and is switched instantaneously in response to, e.g., an external event or the like.

The model equation control information analysis unit 111 in FIG. 1 receives the hybrid model description 104 shown in FIG. 5 described above. The unit 111 analyzes the model description prior to execution of a simulation, and registers all required continuous system equations in the form suitable for the simulation.

More specifically, the model equation control information analysis unit 11l extracts all of descriptions of continuous system equations such as dynamic equations eq1 and eq2, and the like shown in FIG. 5, and those of control information of state transition in response to events such as “Right”, “Left”, and the like shown in FIG. 5, from the hybrid model description 104 prior to execution of the simulation. At the same time, the unit 111 separates these descriptions, and passes them to the equation parsing unit 112, and model equation control information storage unit 113.

The model equation control information analysis unit 111 generates a table, which stores a conditional formula, the ID of a continuous system equation which is activated when the conditional formula holds, and that of a continuous system equation which is deactivated accordingly in association with each other, on the basis of the descriptions of the control information of state transition in response to events. Information expressed by this table corresponds to that in the model equation control information storage unit 113. The continuous system equation switching unit 115 periodically looks up this table during execution of the simulation, and checks the contents in turn. If the conditional formula holds, another API (Application Program Interface) function required to activate or deactivate a corresponding continuous system equation is called in association with the corresponding continuous system equation ID. This API function sets/resets a flag which is assured for that continuous system equation and indicates if that equation is active/inactive. In this way, the continuous system equation is switched. In the second embodiment to be described later, a source program of a second programming language (e.g., C) that calls the API function is generated in place of generation of such table (information in the model equation control information storage unit 113).

The equation parsing unit 112 parses the input continuous system equations, converts them into data structures that allow to execute a simulation, and registers them in the equation data storage unit 114. More specifically, the equation parsing unit 112 parses the description of each individual continuous system equation to decompose it into a plurality of character strings. These character strings which form the description of the continuous system equation are passed as arguments to a predetermined API (Application Program Interface) function required to register the continuous system equation. This API function required to register the continuous system equation converts the description of each continuous system equation into a data structure (internal data expression) that allows to execute a simulation, and registers it in the equation data storage unit 114. Note that a unique ID number is assigned to each individual continuous system equation.

For example, assume that formula “ab/cos(a·(c+b))·3c” is given. Then, the API function generates a tree structure shown in FIG. 6 as the internal data expression. The tree structure includes a parent node 61 of a linear polynomial, to which a multiplication node 62, a division mode 63, an external function (other than four-function operations) node 64, and a node of each term which forms the linear polynomial 65 are in turn connected. In this example, all leaves of the tree structure correspond to variables (a, b, c), and coefficients of real numbers are added to these variables to form linear equations. Each linear equation becomes an argument of an external function such as cos or the like, or to undergo a multiplication or division. Each variable independently has a flag indicating if its value has been settled, and the current value of the variable is held on the basis of such tree structure data. If the values of all the leaves (i.e., those of the variables) of the tree structure have been settled, the value of the formula can be calculated. In the equation data storage unit 114, the tree structure is formed by joining internal data structures in advance so as to calculate the value of the formula and the like at high speed. In this way, according to this embodiment that prepares equation data (the internal data expression with the tree structure) in advance, a simulation can be executed at higher speed than a case wherein a description of formula “ab/cos(a·(c+b))·3c” is parsed upon execution of the simulation.

As a comparative example of this embodiment, a case will be explained below wherein the program description of a hybrid model is executed by an interpreter type language processing system. Such comparative example is, e.g., HCC of Xerox Corporation (TM) explained in the prior art.

Since the interpreter type allows to add equations during execution of a simulation, a process for listing active equations to be solved as simultaneous equations, a process for parsing the listed equations to convert them into internal data structures (shown in, e.g., FIG. 6) suitable for internal calculations, a process for actually solving simultaneous equations, and the like must be done every time numerical integration is done by advancing a time step. Since how many equations can be simultaneously solved cannot be determined in advance upon executing these processes, a required memory is dynamically allocated every time one equation is listed. Since the required memory size differs depending on processes, it is a common practice to allocate a large memory area in advance, and to allocate a required memory from that area. Also, a process for releasing the memory must be done when an equation is deactivated. The released memory can be used for another purpose in the subsequent processes. However, since it is difficult to directly use memories which are dynamically allocated as small segments after they are released, a Garbage Collection process must be executed to collect the released small memory segments, and to reconfigure them as a reusable memory area. Such parsing and memory management processes are complicated and require high computational cost, and may adversely influence execution of a simulation as an original purpose. For example, the Garbage Collection process is launched and execution of a simulation is paused unexpectedly.

By contrast, in the embodiment of the present invention, the model equation control information analysis unit 111 and equation parsing unit 112 are provided, as described above, so as to analyze the whole hybrid model description 104 and to generate and manage the required internal data expression (data such as simple arrays which allow high-speed access). Hence, no problems of the comparative example are posed.

Upon execution of a simulation, the hybrid model simulation execution unit 102 is launched, and executes a simulation by calculating continuous system equation values while receiving the control signal 106 obtained from a mechanism control software simulator 108 or the like. At this time, the continuous system equation switching unit 115 looks up the contents of the model equation control information storage unit 113, and switches continuous system equations using active/inactive flags. In the state shown in FIG. 2, dynamic equation eq1 in FIG. 5 is inactive, and dynamic equation eq2 is active. In the state shown in FIG. 3 after the “Left” event is generated, the unit 115 manipulates flags to activate dynamic equation eq1 in FIG. 5, and to deactivate dynamic equation eq2. These active/inactive flags are managed as attribute data of equations stored in the equation data storage unit 114.

The continuous system simulation unit 103 looks up the equation data storage unit 114, and executes numerical integration in increments of time steps to have the internal data expression of each continuous system equations stored in the form of the tree structure in the storage unit 114 as a calculation target. A simulation is an initial value problem for nonlinear simultaneous equations as simultaneous equations of ordinary differential equations and algebraic equations. Hence, an initial state shown in FIG. 2 is given, and a solution value is calculated using, e.g., a popular Runge-Kutta algorithm.

Required data are output from the mechanism simulator, and the control returns to the process of the continuous system equation switching unit 11 to repeat the above processes, thus executing a simulation for a required period of time. The simulation result is saved in the variable value/time history storage unit 105, and is used in analysis and the like after the simulation.

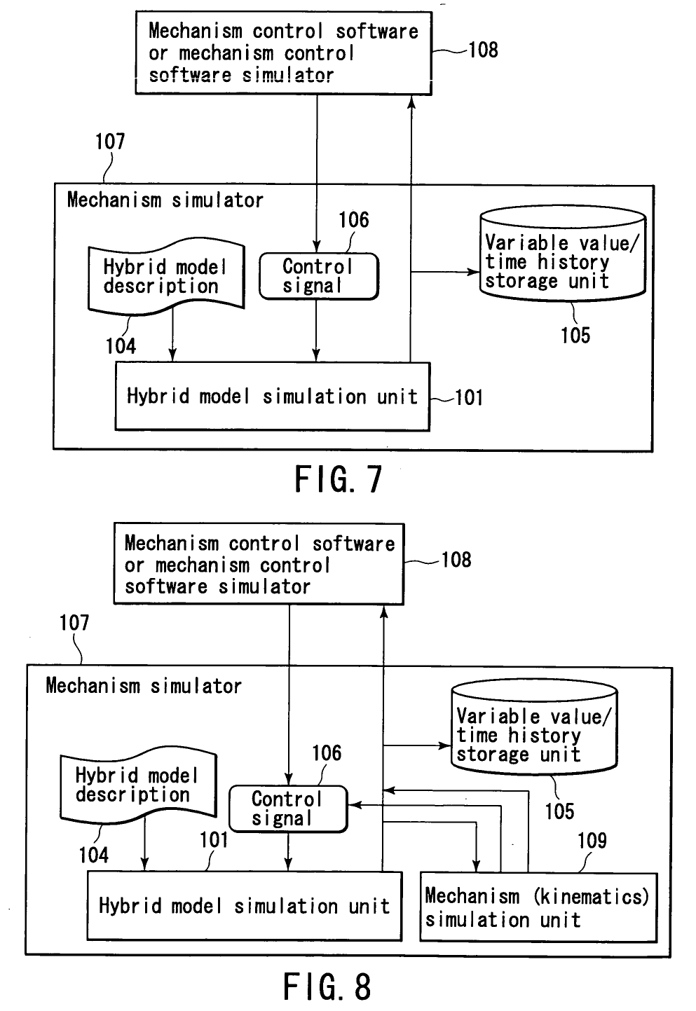

FIG. 7 shows collaboration between the mechanism simulator that has been explained with reference to FIG. 1, and mechanism control software. FIG. 7 simply illustrates the mechanism simulator (hybrid model simulation unit 101) as a black box.

Mechanism control software (or mechanism control software simulator) 108 gives a manipulation command to an actuator such as a motor, a solenoid or the like as building components of a mechanism to be simulated as the control signal 106. In response to this signal, the hybrid model simulation unit 101 executes a simulation to generate required data such as sensor information of a photosensor or the like provided to the mechanism to be simulated, and sends them to the mechanism control software 108. The mechanism control software 108 can virtually exchange the same data as those to be exchanged with an actual machine with the mechanism simulator 107 at appropriate timings, and can implement a verification operation of software while no actual machine is available.

FIG. 8 shows a case wherein a kinematics simulation unit 109 is added to the arrangement shown in FIG. 7. With the arrangement of FIG. 8, the mechanism simulator (hybrid model simulation unit 101) can further obtain kinematical analysis information (e.g., a change in angle of a motor shaft along with an elapse of time) on the basis of the kinematics simulation unit 109. The kinematics simulation unit 109 can also calculate, e.g., the posture of the mechanism and the like on the basis of the obtained motor angle and the like in each time step. As a result, the mechanism simulator can check if, for example, a robot arm intercepts a light beam of a photosensor. That is, when a mechanism object with a complicated shape moves in a three-dimensional (3D) space, the state of the sensor and the like can be efficiently calculated. As for details of a practical implementation method of the kinematics simulation unit 109 and required elemental techniques, refer to Jpn. Pat. Appln. KOKAI Publication Nos. 2000-137740, 2001-282877, 2002-215697, and the like, which are associated with Japanese Patent Applications by the same assignee as the present invention.

Also, commercially available mechanism analysis software, a mechanism simulation function of 3D CAD, and the like may be used. Also, the technique described in Jpn. Pat. Appln. KOKAI Publication No. 2001-222572 can be referred to although it does not provide any function of modeling the behavior of a mechanism using a model description language such as a hybrid model in association with the arrangement shown in FIG. 8.

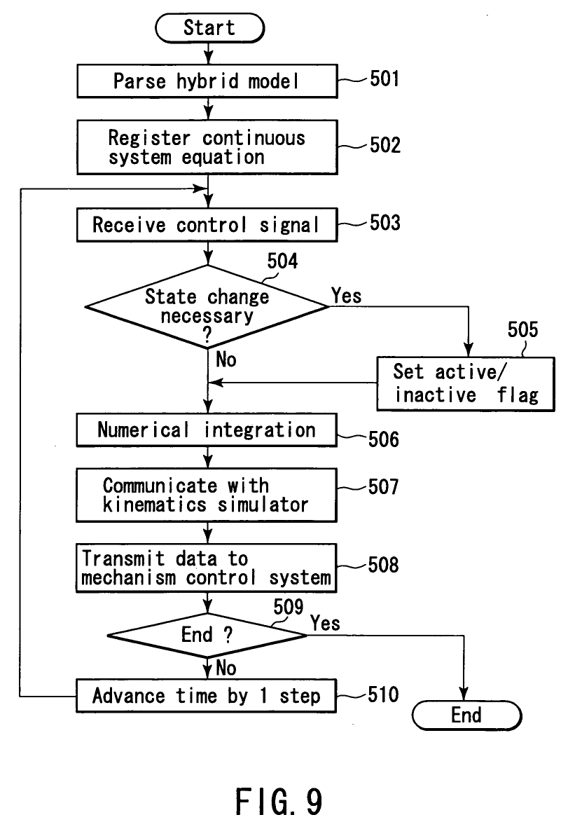

FIG. 9 is a flow chart showing the sequence of a series of processes in a simulation according to the aforementioned first embodiment of the present invention. Note that the flow chart of FIG. 9 shows the processes for the arrangement shown in FIG. 8, i.e., the arrangement which comprises the kinematics simulation unit 109.

The model equation control information analysis unit 111 and equation parsing unit 112 receive and parse the hybrid model description 104 (step 501). The unit 111 generates a table, which stores a conditional formula, the ID of a continuous system equation which holds when the conditional formula holds, and that of a continuous system equation which is deactivated accordingly in association with each other, on the basis of the descriptions of the control information of state transition in response to events, and stores that table in the model equation control information storage unit 113. Also, the unit 111 converts the descriptions of continuous system equations into data structures that allow to execute a simulation on the basis of their parsing results, and registers the converted structures in the equation data storage unit 114 (step 502).

The pre-process for a simulation has been done, and a simulation execution process then starts. A reception process of the control signal 106 supplied from the mechanism control software simulator 108 or the like is executed (step 503). In this case, values based on the received control signal are substituted in variables as needed, if necessary. Then, it is determined in step 504 if a state change is necessary. If a state change is necessary, the continuous system equation switching unit 115 switches continuous system equations as needed by manipulating active/inactive flags of corresponding continuous system equations (step 505).

The continuous system simulation unit executes numerical integration (step 506). Then, a communication process is executed between the hybrid model simulation unit 101 and kinematics simulation unit 109 (step 507). More specifically, the hybrid model simulation unit 101 and kinematics simulation unit 109 exchange motor angle information, sensor information, and the like. In case of the arrangement which does not comprise any kinematics simulation unit 109 as in FIG. 7, step 507 is skipped.

The mechanism simulator transmits sensor information and the like to the mechanism control software simulator 108 (step 508). Furthermore, it is checked in step 509 if the process is to end. After that, the time is advanced by one step until a predetermined end condition is met (step 510). The simulation is executed by repeating the processing sequence in step 503 and subsequent steps.

In order to allow the hybrid model simulation unit 101 to efficiently execute a simulation in collaboration with the mechanism control software simulator 108 and kinematics simulation unit 109 as a whole, the execution order among steps 504, 505, and 506 that exclusively execute processes according to the contents of the hybrid model description 104, and steps 503, 507, and 508 that exclusively execute data transmission/reception and the like must be efficiently controlled. As has already been described previously, in the conventional system, in order to program to appropriately and efficiently control the execution order, operations that require very high skills and difficulty must be made due to the characteristics of the hybrid model description language (a line to be executed first cannot be determined). In addition, special external functions and the like associated with an interface with external processes (e.g., externally obtained information must be substituted in each variable upon processing a hybrid model in place of simply handling variable values) must be prepared, and the model creator must describe them.

By contrast, according to the embodiment of the present invention, since the hybrid model simulation execution unit 102 is configured to execute a series of processes shown in FIG. 9, the aforementioned problems can be avoided. That is, a software module corresponding to a communication with external processes such as the mechanism control software simulator 108 and the like is permanently installed independently of a hybrid model. Such software module is commonly called as “(simulation) engine”, and is provided as an embodiment according to the present invention. Which of variables externally obtained data are to be substituted in must be input independently of the hybrid model description 104. However, upon generating the hybrid model description 104, the user need only understand variable names alone in which externally obtained data are substituted, and can create (program) a model regardless of the sequence of communications and the like.

As described above, according to this embodiment, the hybrid model description 104 is analyzed prior to execution of a simulation, and all required continuous system equations are registered in the form suitable for the simulation. In addition, especially in the first embodiment, a table for execution control, which is associated with state transition based on a generated event and the like, is generated. In a simulation, the continuous system equation switching unit 115 looks up this table. If it is determined that equations must be switched (replaced) upon state transition, that process can be easily implemented by manipulating (setting/resetting) active/inactive flags of corresponding continuous system equations. According to such scheme, the simulation execution speed drop due to parsing of a model description, Garbage Collection (GC) process, and the like during simulation can be avoided. The mechanism simulator of the first embodiment internally executes the aforementioned processing sequence unique to the present invention, but is interpreter like in appearance. For example, the storage units 113, 114, and the like that store the table, equation data, and the like are formed using a storage device such as a RAM or the like.

### SECOND EMBODIMENT

The second embodiment of the present invention will be described below.

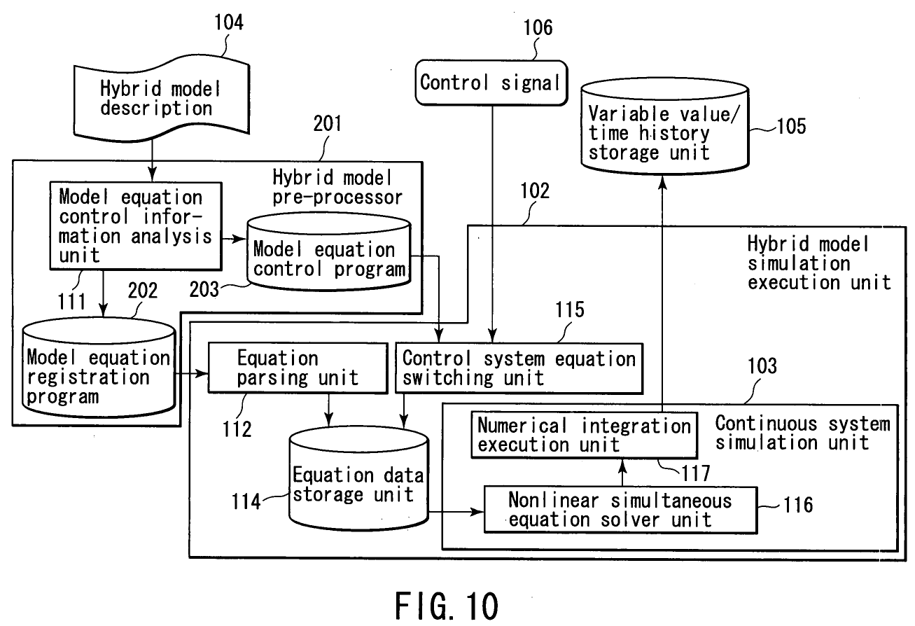

FIG. 10 is a schematic block diagram showing the arrangement of a mechanism simulator according to the second embodiment of the present invention. The arrangement of the second embodiment is substantially the same as that of the first embodiment, except that the model equation control information analysis unit 111 is independent of the hybrid model simulation execution unit 102 as a hybrid model pre-processor 201. In the second embodiment, the hybrid model description 104 is processed by the hybrid model pre-processor 201 to generate a model equation registration program 202 and model equation control program 203. Also, as a software module which forms the hybrid model simulation execution unit 102, a function required to register model equations, and a function of switching continuous system equations are provided as API (Application Program Interface) functions.

The model equation registration program 202 and model equation control programs 203 are prepared by appropriately combining descriptions that call the aforementioned API functions in accordance with the input hybrid model description 104, and are generated by the model equation control information analysis unit 111. From this viewpoint, the hybrid model pre-processor 201 can be considered as a type of compiler, which receives the hybrid model description 104 and outputs, e.g., a C program (source) that contains the descriptions which calls API functions in C. The model equation registration program 202 and model equation control programs 203 are compiled by a compiler for C or the like to generate libraries that allow dynamic links upon execution. The hybrid model simulation execution unit 102 is linked with the generated dynamic link libraries upon execution of a simulation, thus completing a simulation program which faithfully reproduces a hybrid model and is ready to execute. Upon execution of this program, an API function that launches the equation parsing unit 112 is called, and API functions required to switch continuous systems are then executed, thus performing a simulation.

The differences between the first embodiment with the arrangement shown in FIG. 1, and the second embodiment with the arrangement shown in FIG. 10 will be described in more detail below.

In each of these embodiments, various detailed software module specifications, which form an application interface of the hybrid model simulation unit 102, are available. However, for the sake of simplicity, assume that at least the following three API functions are defined. Note that the programming language is C.

int XXX_AddEqnData(char *eqn, int *err)

int XXX_ActivateEqn(int eqnid)

int XXX_DeActivateEqn(int eqnid)

The first API function XXX_AddEqnData designates, as an argument, a pointer of a character string which represents one continuous system equation. XXX_AddEqnData executes a process for parsing this continuous system equation to convert it into the data structure shown in FIG. 9 above, and registering such internal data expression in the equation data storage unit 114. If any error has occurred in this process, an error code is set in err. If the process has normally terminated, the ID number of the registered equation is output as a return value.

The second API function XXX_ActivateEqn activates an equation corresponding to the equation ID number designated as an argument. If an equation that has already been activated is designated, no process is made. The return value is an error code.

The third API function XXX_DeActivateEqn deactivates an equation corresponding to the equation ID number designated as an argument, contrary to XXX_ActivateEqn. If an equation that has already been deactivated is designated, no process is made.

In the first embodiment, as described above, the model equation control information analysis unit 111 extracts individual equations from the hybrid model description 104, and the equation parsing unit 112 decomposes each equation into a plurality of character strings. These character strings which form the equation are passed as arguments to XXX_AddEqnData. In this manner, the internal data expressions of the equations are registered and stored in the equation data storage unit 114. At the same time, each equation is assigned with a unique ID number. The model equation control information analysis unit 111 generates, as internal data of the model equation control information storage unit 113, a table that stores a conditional formula, the ID of an equation which is activated when that conditional formula holds, and the ID of an equation which is deactivated accordingly. The continuous system equation switching unit 115 periodically checks this table during execution of a simulation, and checks the contents of the table in turn. If a conditional formula holds, XXX_ActivateEqn or XXX_DeActivateEqn is called to activate or deactivate a continuous system equation in association with the corresponding continuous system equation ID.

By contrast, in the second embodiment, the model equation control information analysis unit 111 generates a function (InitEqnData) that calls XXX_AddEqnData in turn for a required equation. This corresponds to the model equation registration program 202.

The model equation control information analysis unit 111 also generates a function (ChangeEqn) that checks a condition and changes (replaces) an equation every time the time advances At. This corresponds to the model equation control program 203. In the first embodiment, this function corresponds to the internal table data and the equation switching mechanism that looks up the table data. In the second embodiment, this function is implemented in the form of a practical source program. For example, the following source program in C is automatically generated for a hybrid model example shown in FIG. 5.

```
static char eqn1[] = “f = m x‘’”;
static char eqn2[] = “−f = m x‘’”;
static int eqn1id;
static int eqn2id;
int InitEqnData( )
{
  int err;
  eqn1id = XXX_AddEqnData(eqn1,&err);
  if(err != 0 ) return err;
  eqn2id = XXX_AddEqnData(eqn2,&err);
  if(err != 0 ) return err;
  return 0;
}
int ChangeEqn( )
{
  int err;
  BOOL GetEvent(char *eventname);
  if( GetEvent(Left) ){
    err = XXX_ActivateEqn(eqn1id);
    if( err != 0 ) return err;
    XXX_DeActivateEqn(eqn2id);
    if( err != 0 ) return err;
}
if( GetEvent(Right) ){
    XXX_ActivateEqn(eqn2id);
    if( err != 0 ) return err;
    XXX_DeActivateEqn(eqn1id);
    if( err != 0 ) return err;
}
return 0;
}
```

Note that GetEvent is a function of checking if an event designated by a name has occurred. The aforementioned programs are compiled by the C compiler, as described above, and are converted into dynamic link libraries, which are linked upon execution. In this way, in case of this embodiment that automatically generates a (source) program, the source program includes statements of eqn1id and eqn2id, i.e., specifies that only two equations appear. Hence, it is preferable that a memory size assigned upon execution need only be sufficiently allocated for these two equations. In the first embodiment, the table as internal data of the model equation control information storage unit 113 is not expanded in principle after the beginning of a simulation. When the table is generated for the first time before the beginning of a simulation, a memory required to hold the table can be allocated in accordance with the table size obtained from the model equation control information analysis unit 111.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A simulation method of simulating a behavior of a mechanism using a hybrid model including a state transition model and a continuous system model, the method comprising:
analyzing the hybrid model to extract a first description data of a state transition model and a second description data of a continuous system model;
generating a table representing a relationship between continuous system equations and switching conditions thereof, based on the extracted first description data;
generating a plurality of internal data expressions of the continuous system equations, based on the extracted second description data;
selecting an active continuous system equation by looking up the table according to an occurrence of an event; and
outputting data that represents the behavior of the mechanism by solving the selected active continuous system equation by numerical integration using one or more of the internal data expressions that corresponds to the selected active one or more continuous system equations.

2. The method according to claim 1, further comprising:
switching the active one of the continuous system equations to the another continuous system equation by operating a flag assured for each of the continuous system equations.

3. The method according to claim 1, wherein the event is responsive to one of a control signal and an evaluation result of an internal variable, the control signal being provided from an external process including mechanism control software that controls the mechanism.

4. The method according to claim 1, further comprising executing a kinematics simulation which uses the data that represents the behavior of the mechanism.

5. A simulation method of simulating a behavior of a mechanism using a hybrid model including a state transition model and a continuous system model, the method comprising:
analyzing the hybrid model to extract a first description data of a state transition model and a second description data of a continuous system model;
generating a table representing a relationship between continuous system equations and switching conditions thereof, based on the extracted first description data;
generating a plurality of internal data expressions of the continuous system equations, based on the extracted second description data; and
performing a simulation of the behavior of the mechanism while referring to the table and the plurality of internal data expressions of the continuous system equations.

6. A simulation method of simulating a behavior of a mechanism using a hybrid model including a state transition model and a continuous system model, the method comprising:
analyzing the hybrid model to extract a first description data of a state transition model and a second description data of a continuous system model;
generating a first program code based on the extracted first description data;
generating a second program code based on the extracted second description data;
generating a plurality of internal data expressions of the continuous system equations by executing the second program;
switching continuous system equations according to switching conditions thereof by executing the first program; and
outputting data that represents the behavior of the mechanism by solving the continuous system equations by numerical integration using the internal data expressions.

7. A simulation apparatus which simulates a behavior of a mechanism using a hybrid model including a state transition model and a continuous system model, comprising:
an analyzing unit configured to analyze the hybrid model to extract a first description data of a state transition model and a second description data of a continuous system model;
a first generating unit configured to generate a table representing a relationship between continuous system equations and switching conditions thereof, based on the extracted first description data;
a second generating unit configured to generate a plurality of internal data expressions of the continuous system equations, based on the extracted second description data; and
a-simulation execution unit configured to:
select an active continuous system equation by looking up the table according to an occurrence of an event; and
output data that represents the behavior of the mechanism by solving the selected active continuous system equation by numerical integration using one or more of the internal data expressions that corresponds to the selected active one or more continuous system equations.

8. The apparatus according to claim 7, wherein the simulation execution unit switches an active one of the continuous system equations to another continuous system equation by operating a flag assured for each of the continuous system equations.

9. The apparatus according to claim 7, wherein the event is responsive to one of a control signal and an evaluation result of an internal variable, the control signal being provided from an external process including mechanism control software that controls the mechanism.

10. The apparatus according to claim 7, further comprising a kinematics simulation execution unit configured to execute a kinematics simulation which uses the data that represents the behavior of the mechanism.

11. A simulation apparatus which simulates a behavior of a mechanism using a hybrid model including a state transition model and a continuous system model, comprising:
an analyzing unit configured to analyze the hybrid model to extract a first description data of a state transition model and a second description data of a continuous system model;
a first generating unit configured to generate a table representing a relationship between continuous system equations and switching conditions thereof, based on the extracted first description data;
a second generating unit configured to generate a plurality of internal data expressions of the continuous system equations, based on the extracted second description data; and
a simulation execution unit configured to execute a simulation of the behavior of the mechanism, while referring to the table and the plurality of internal data expressions of the continuous system equations.

12. A simulation apparatus which simulates a behavior of a mechanism using a hybrid model including a state transition model and a continuous system model, comprising:
an analyzing unit configured to analyze the hybrid model to extract a first description data of a state transition model and a second description data of a continuous system model;
a first generating unit configured to generate a first program code based on the extracted first description data;
a second generating unit configured to generate a second program code based on the extracted second description data;
a third generating unit configured to generate a plurality of internal data expressions of the continuous system equations by executing the second program;
a switching unit configured to switch continuous system equations according to switching conditions thereof by executing the first program; and
an outputting unit configured to output data that represents the behavior of the mechanism by solving the continuous system equations by numerical integration using the internal data expressions.

13. A computer program stored in a computer readable medium for simulating a behavior of a mechanism using a hybrid model including a state transition model and a continuous system model, the program comprising:
means for instructing a computer to analyze the hybrid model to extract a first description data of a state transition model and a second description data of a continuous system model;
means for instructing the computer to generate a table representing a relationship between continuous system equations and switching conditions thereof, based on the extracted first description data;
means for instructing the computer to generate a plurality of internal data expressions of the continuous system equations, based on the extracted second description data; and
means for instructing the computer to select an active continuous system equation by looking up the table according to an occurrence of an event; and
means for instructing the computer to output data that represents the behavior of the mechanism by solving the selected active continuous system equation by numerical integration using one or more of the internal data expressions that corresponds to the selected active one or more continuous system equations.

14. The program according to claim 13, further comprising means for instructing the computer to switch an active one of the continuous system equations to another continuous system equation by operating a flag assured for each of the continuous system equations.

15. The program according to claim 13, wherein the event is responsive to one of a control signal and an evaluation result of an internal variable, the control signal being provided from an external process including mechanism control software that controls the mechanism.

16. The program according to claim 13, further comprising means for instructing the computer to execute a kinematics simulation which uses the data that represents the behavior of the mechanism.

17. A computer program stored in a computer readable medium for simulating a behavior of a mechanism using a hybrid model including a state transition model and a continuous system model, the program comprising:
means for instructing a computer to analyze the hybrid model to extract a first description data of a state transition model and a second description data of a continuous system model;
means for instructing the computer to generate a table representing a relationship between continuous system equations and switching conditions thereof, based on the extracted first description data;
means for instructing the computer to generate a plurality of internal data expressions of the continuous system equations, based on the extracted second description data; and
means for instructing the computer to execute a simulation of the behavior of the mechanism, while referring to the table and the plurality of internal data expressions of the continuous system equations.

18. A computer program stored in a computer readable medium for simulating a behavior of a mechanism using a hybrid model including a state transition model and a continuous system model, the program comprising:
means for instructing a computer to analyze the hybrid model to extract a first description data of a state transition model and a second description data of a continuous system model;
means for instructing the computer to generate a first program code based on the extracted first description data;
means for instructing the computer to generate a second program code based on the extracted second description data;
means for instructing the computer to generate a plurality of internal data expressions of the continuous system equations by executing the second program;
means for instructing the computer to switch continuous system equations according to switching conditions thereof by executing the first program; and
means for instructing the computer to output data that represents the behavior of the mechanism by solving the continuous system equations by numerical integration using the internal data expressions.
